(19) United States
(12) Patent Application Publication
(10) Pub. No.: US 2025/0154719 A1
(43) Pub. Date: May 15, 2025

(54) PRODUCTION OF CELLULOSE FROM COTTON OR COTTON BLENDS

(71) Applicant: EEDEN GERMAN UG, Mönchengladbach (DE)

(72) Inventors: Reiner MANTSCH, Münster (DE); Mathias LEIMBRINK, Münster (DE); Arne HÜNEKE, Münster (DE)

(21) Appl. No.: 18/838,395

(22) PCT Filed: Feb. 13, 2023
(86) PCT No.: PCT/DE2023/150006

§ 371 Date: Aug. 14, 2024

(30) Foreign Application Priority Data
Feb. 15, 2022 (DE) 10 2022 000 572.7

(51) Int. Cl. D21B 1/02; C08J 11/14; C08L 1/02; D21B 1/04; D21H 13/08

(52) U.S. Cl. CPC D21B 1/02; C08J 11/14; C08L 1/02; D21B 1/04; D21H 13/08; C08J 2301/02; C08J 2367/03

(57) ABSTRACT

A method for the production of a cellulosic polymer with a cellulose content of at least 92% from textile waste material, wherein an educt of a mixture of cotton and PET with a fire length of at most 1 mm is treated in a reactor with subcritical water at a temperature of 130-200° C., particularly preferably between 160° C.-200° C. and a pressure in a range of between 1-25 bar, preferably between 1-10 bar for about 1-120 mins and wherein a cellulose polymer with an average degree of polymerisation of between 450-650 is formed.

### CROSS-REFERENCES RELATED TO APPLICATIONS

This application is a National Stage application of International Patent Application No. PCT/DE2023/150006, filed on Feb. 13, 2023, which claims priority to German Patent Application No. 102022000572.7, filed on Feb. 15, 2022, each of which is hereby incorporated by reference in its entirety.

### TECHNICAL FIELD

The present invention relates to the production of cellulose from cotton and cotton blends.

### BACKGROUND

The circular economy is one of the more topical issues influencing joint efforts to achieve a sustainable and environmentally conscious approach to raw materials and energy consumption. Starting with the question of reuse (can I still wear it?) from the orderly sorting and collection to the recycling and reuse of the “raw materials” now obtained, many problems have to be thought through and then solved. Political efforts are partly supporting these processes, for example through a new version of an EU directive dealing with used textiles and their collection. One obstacle to the reprocessing and reuse of old textiles is the fact that recycling the fibers is usually more expensive than producing new ones. One of the reasons for this is the complexity of the fiber material, which in many cases consists of more than one fiber, as well as the large fluctuations in the molecular properties of cellulose, such as those found in DP. This of course has advantages in terms of the functionality of the materials, but when returning them to the product cycle, fiber mixtures now have to be processed, which requires complex separation processes.

The processing of pure raw materials such as cotton into cellulose is known in the prior art, but the products are not of the desired quality. This is due to the use of aggressive additives and the energy-consuming processing steps. These affect the quality of the end products. The addition of acids and/or bases as catalysts or other reaction partners leads to unstable polymer fibers and undesirable by-products such as terephthalic acid, which are difficult to remove from the reaction mixture. In addition to purity, the average degree of polymerization is the most important quality parameter for cellulose.

### SUMMARY

It is therefore the object of the present invention to provide a method for obtaining high-quality polymer fibers having a cellulose content of at least 90%, wherein the DP value is additionally in a determined range.

This object is achieved by a method for the production of a cellulose polymer with a cellulose content of at least 90%, preferably 92%, from textile waste material, wherein an educt of cotton or of a mixture of cotton and PET with a fiber length of at most 1 mm is treated in a reactor with subcritical water at a temperature of 130-180° C. and a pressure in a range of 1-10 bar for approx. 1-120 min and wherein a cellulose polymer with an average degree of polymerization (DP), which can be predetermined, of 300-1000 DP, preferably 450-650, is produced. The educt can of course also consist of pure cotton. The predetermination of the DP value plays a decisive role here, as the quality of the end materials to be produced is designed for a purity in a certain DP value range. Lyocell, for example, is obtained from a pulp with a DP value of 550-600, viscose from a pulp with a DP of 300-700. Here, the DP consistency in the pulp is a guarantee for the quality of the end product. The present method thus allows the DP range of the pulp to be determined in advance.

### DETAILED DESCRIPTION

A cellulose polymer with a purity of 90%- 92% and more is a high-quality raw material that can be used for the production of a plurality of other high-quality products. As already mentioned above, viscose and lyocell are the manufacturing targets. Viscose is normally produced from chemical cellulose, which is obtained from various types of wood or cotton. Here, the quality of the cellulose differs from that used for paper production, as cellulose with a determined chain length and purity must be used. Lyozell fibers are known for their high dry and wet strength, they are soft and absorb moisture very well. The textiles made from this material have a “smooth” and “cool” feel with a flowing drape. They are almost crease-resistant and can be washed and dry-cleaned. To ensure that these features are present, only extremely pure raw materials can be used for production. Furthermore, the DP values must also be adjusted for seamless further processing by the fiber manufacturer. They should meet the fiber-specific requirements and are present in a DP range predefined by the fiber manufacturer. Depending on the viscose fiber, this lies in a range between 300-700. Cellulose for lyocell fibers have a DP of 500-700, or even better 550-600.

The polymer fiber produced by these methods according to the invention is thus an “upcycling” product. The fiber length of the raw material of no more than one millimeter only means that the raw material has been ground beforehand. This allows the subsequent reaction to take place more easily. The fiber length also serves to standardize the process parameters, which have to be selected differently for different fiber lengths. We will come back to this later. It was found that the method according to the invention is particularly advantageous for the production of high-purity cellulose with a predefined DP in the area of 300-1000 from textile waste. In a very special embodiment, fiber lengths of the educt in the range of 0.2 mm to 8 mm are used. The shorter fibers mix better in the water.

The method is based on the use of a reactor with subcritical water. Subcritical water here refers to liquid water at temperatures between the atmospheric boiling point, i.e. 100° C., and the critical temperature, i.e. 374° C. Under these conditions, water has special, otherwise unusual properties. This affects its density, dielectric constant, ion concentration, diffusivity and solubility in the subcritical state. In this state, the ionization constant increases with temperature and is approximately three orders of magnitude higher than for water in its normal state. The dielectric constant drops from 80 to 20. Such a drastic change in physical properties causes the cross-linking of the textile waste material, which consists of cotton and PET, to dissolve quickly.

The fact that the water assumes a different pH value due to the increase in the ionization constant also has a partial effect here. This is sufficient to cleave the cellulose chains of the cotton fibers and thus make a targeted DP adjustment in a target DP range. This shows that the resulting cellulose, in addition to the DP, also has good dissolving properties and high purity.

Treating fabrics in an aqueous system at high temperature and under pressure is called the hydrothermal method. The reactor is therefore a hydrothermal reactor. The temperature used in the reactor is in a range between 130° C.-200° C. or particularly preferably 160° C.-200° C. The pressure is regulated to a range between 1-25 bar. The reaction time is between 1-120 minutes. With the set parameters, the reactor can affect the raw material, i.e. the textile waste, at the fiber level and weaken the bond strength between the fibers or even loosen the interwoven fiber strands from one another. At the same time, any polyester residues that may be present are also decomposed. The degree of polymerization of the products can also be influenced with the aid of the operating parameters that are decisive for the operation of the reactor. It should be indicated here that subcritical water as a solvent is non-toxic, environmentally friendly and cost-effective. It is naturally PH-neutral and therefore unaggressive as a solvent.

The product, the cellulose polymer, now not only has a degree of purity of at least 90%-92%, but also an average degree of polymerization (DP) of 300-1000 or even 450-650. If the reaction is very well adjusted, the product even has an average degree of polymerization (DP) of 550-600. This degree of polymerization then testifies to a homogeneous reaction, wherein the educt is degraded to such an extent that it can be optimally processed into lyocell. The degree of polymerization indicates the number of basic building blocks per polymer molecule. It is identical to the quotient of the mean molar mass of the polymer and the molar mass of its repeating unit (the monomer unit). The exact number can usually only be a mean value over the sample under consideration. This mean value is referred to as the average degree of polymerization (DP). For fiber-forming polymers, it is an important parameter for the processing and usage properties.

The degree of polymerization of a sample is usually determined by its molar mass. There are a number of methods for this, e.g. GPC, some methods for determining colligative properties (such as cryoscopy, vapor pressure osmosis, etc.), viscometry, light scattering, etc. Other methods are of technical importance, but require precise calibration of the sample system. The melt flow index method should be mentioned here. For example, the viscosity of a plastic melt increases as the degree of polymerization increases; the mean value can be determined indirectly (i.e. relative to a chemically comparable standard) using the MFI method.

The degree of polymerization and the spatial geometric distribution of the monomers in the molecule (i.e. the stereochemical arrangement of the molecular branches) have a great influence on the physical and especially the mechanical characteristics of a polymer. However, according to Staudinger, the fiber strength does not change proportionally with the degree of polymerization. The DP is e.g. for cotton 3000, viscose fibers 250-700, polyamides 100-180 and polyester 130-220. Determining the average degree of polymerization is particularly important for cellulose fibers, as it allows chemical damage to these fibers to be characterized numerically. In a favorable case, the cotton/PET mixture consists of a composition with a PET part of up to 5%. However, it is not an obstacle for the present method according to the invention if the foreign fiber portion does not consist of PET but of another fiber. These foreign fibers are also processed without affecting the end product. Experiments with a foreign fiber content of up to 5% show no impairment of the method sequence and the end product at all. If the foreign fibers are made of elastane or PES/PET, they are lost in the end product. It is also irrelevant whether the fiber mixture contains colored components. Azo dyes, sulphur dyes, diphenylmethane dyes, thiazole dyes, triphenylmethane dyes, nitro dyes, anthraquinone dyes, nitroso dyes, indigo dyes, quinoline dyes, indigosol acridine dyes, quinonimine dyes, cyanine dyes (azines, oxazines, thiazines) and phthalocyanine dyes are completely unproblematic. These are the most commonly used textile dyes at the moment. In some methods, the dyes are removed from the educt in an upstream step. However, this is not the case in the present method. Furthermore, the educt can have a metal content of >10 ppm. Both small metal residues and large metal contents are reliably dissolved out of the educt. However, alkaline earth and alkali metals, as well as many heavy metals, are responsible for the formation of lumps in the reaction mixture. The clumping can clog the filter and thus impair the reaction. It has also been noticed that the heavy metals have a catalytic effect and thus cause undesirable side reactions. However, if the heavy metals are present in ranges below 10 ppm, the reaction is not affected. The addition of antioxidants can be used to support high levels of heavy metals. Likewise, the method according to the invention is not impaired by the presence of the educt in suspension form. If the educt is present in a degree of polymerization of more than 700. The product has a DP of 450-650. The method thus enables the cellulose fibers in the textile waste material to be reduced in size, the cellulose fibers to be detached from the textile waste material, or both.

The catalyst-free reaction sequence is important. In the known methods, the fibers are usually digested with the help of acids or bases, adapted to the DP and then further processed.

The disadvantage of this pH-effective addition of materials is that the end product is impaired by the aggressive chemicals. These are then removed from the reaction mixture in an additional step, but the damage has already been done. The additional cleaning step naturally also causes effort, costs and is very time-consuming. Disposal of the solvent is also made more complicated by the contamination. Therefore, the catalyst-free reaction in the inventive method is an important step towards a sustainable, environmentally friendly and, at the reaction temperatures present, energy-saving method for recycling textiles. PH neutralization of the pulp no longer needs to be performed. The pH value during the totality of the method is approximately 5.0 to 9.0. The reaction takes place in subcritical water at temperatures between 130-180° C. The reaction time is between 1 and 120 minutes and a pressure of 1-25 bar is applied. The pH-neutral reaction medium (values of 5-7 were measured here) has a solid/liquid ratio of 1:10 up to 1:20. No acids, bases or other catalysts are added. The method is carried out in the absence of oxygen. However, oxygen added in a controlled or permitted manner can cause oxidative changes, particularly in the DP value. Furthermore, it has been shown that even smaller applied pressure ratios of up to 1 or 10 bar are sufficient to run the method favorably.

This means that only filtering, washing, pressing and drying by evaporator (to a dry content of approx. 90%, for example) are necessary to obtain the product. No step for PH neutralization of the pulp is performed. This is unnecessary. The product is then only cut to size for further use.

In the following, it should be noted that the fiber length of the educt understandably has an influence on the stirrability of the mixture. This also has an effect on the reaction. For example, the mixture is stirrable at a reactant fiber length of 1 mm and a weight proportion of 2.5 wt. %, difficult to stir at a weight proportion of 5 wt. % and no longer stirrable at a weight proportion of 7.5 wt. %.

With a reactant fiber length of 0.2 mm, however, the mixture is easily stirrable at a weight proportion of 2.5 wt. %, easily stirrable at a weight proportion of 5 wt. % and still stirrable at a weight proportion of 7.5 wt. %.

The used cutting mill, namely the Fritsch, PULVERISETTE 19 universal cutting mill (5000 watt, 400 V, 3˜50/60 Hz, 13 Nm, speed: 300-3000 rpm, sieve insert size: 0.2-1 mm) has proven to be particularly suitable. However, the use of other granulators is also possible.

Non-limiting exemplary embodiments of the present invention are discussed below.

Old textiles consisting of cotton with a PET part of 5% are cut to a fiber length of 1 mm after sorting. This relatively short reactant length was initially only used in order to be able to compare the many experiments or series of experiments with one another. Of course, the length of the raw materials plays a role in the reaction behavior of the current method, simply because of the different surfaces. The device for shredding can be a normal tea shredder. However, the lengths of the torn and shredded textile waste should be as equal as possible. As mentioned above, the degree of coloration of the waste is irrelevant. Almost all textile dyes are dissolved out in the ongoing method. The presence of the raw materials as a suspension, i.e. finely dispersed in a liquid, is also not detrimental to the method according to the invention.

The raw material can have an average degree of polymerization of more than 700 and can still be processed well. The higher the degree of polymerization in the raw product, the more complex the depolymerization that takes place in the reaction method. Finally, average degrees of polymerization of 300-1000, usually 450-650 or even 550-600 are achieved. The more homogeneous and precise the DP of the end product has been adjusted, the better the end product can be processed. In this method according to the invention, therefore, no preparatory reaction step is required.

The raw materials were now filled into the high-pressure laboratory reactor type BR-300 called high reactor from Berghof. With a maximum achievable temperature of 300° C. and a maximum pressure build-up of 200 bar, this reactor is perfectly adequate for the present inventive method. Among other things, the following 6 experiments were performed in the reactor.

| Test | Severity | T in | t in | Solid:liquid |
|---|---|---|---|---|
| no. | factor | ° C. | min | ratio |
| 1 | 3.54 | 160 | 60 | 1:20 |
| 2 | 3.87 | 160 | 127 | 1:20 |
| 3 | 4.20 | 180 | 70 | 1:20 |
| 4 | 4.54 | 180 | 153 | 1:20 |
| 5 | 4.87 | 200 | 85 | 1:20 |
| 6 | 5.20 | 200 | 180 | 1:20 |

With a solid: liquid ratio of 1:20 and different temperatures in a range of 160° C. to 200° C., reaction times of 60 min to 180 min and a severity factor in an area of 3.54 to 5.20, the average degrees of polymerization shown in the table below were measured. The severity factor is a severity coefficient for the subcritical liquid-hot water pretreatment of products, in this case used textiles. Severity factor, in mathematical terms, is the integral of the vapor temperature or temperature and the exposure time. It is therefore a measure of the severity or intensity of the overall reaction conditions in a chemical reaction; in our case the temperature, the pressure. The time and temperature can be read off the table. The reaction pressure is between 1 and 10 bar. The solid: liquid ratio ranged from 1:10 to 1:20 in the experiments.

No catalyst was added. It is therefore a catalyst-free reaction method. The final mass is filtered, washed, pressed and liquid residues are evaporated to a dry content of approx. 90%. It should be noted again that each additional step, including the neutralization of the pulp, is not necessary. The product was then cut to size. The product now had the following properties:
Cellulose content >90%- 92%
Average degree of polymerization 300-1000 better still 450-650 in the optimum case: 550-600. It should be noted that the different end products require different DP values.
Uncolored/whiteness of >80 (according to ISO)
Metal content: <10-20 ppm

Due to the small number of educts, the by-products are also only found in small numbers and low concentrations. These are some oligomers, glucose, fructose and xylose. The concentrations of the fabrics are negligible and are almost 0 g/L.

In the course of the individual experiments and coordination with the various processing companies, it turned out that the following requirements were also met for the raw products, namely:
1. a cellulose content >92%,
2. a silicate content <80 ppm
3. a calcium content <80 ppm,
4. an iron content <10 ppm and
5. the moisture content 10%

The values apply to viscose and even to lyocell as an end product.

Another processing plant specified the following:
high purity=cellulose content (alpha-cellulose/long-chain cellulose) >90%
small quantities at Hemicellulose: <5%
small quantities of lignin: <0.1%
small quantities to heavy metals: <10ppm

The X-axis shows the temperature/time reaction pair, the Y-axis shows the degree of polymerization (DP). It is possible to see exactly which parameters can be used to set the DP values.

The average degree of polymerization was determined in accordance with the relevant DIN standard.

Here
the cellulose is dried in the oven at 60° C. overnight,
then 50 mg of cellulose are transferred to a 50 ml rotary joint container (c=1 g/L)
subsequently 2-4 copper spirals and approx. 20 small ceramic balls are added. The copper spirals serve as antioxidants and the ceramic balls to displace dead volume in the container.
50 ml Cuoxam solution is added to the container.
The container is closed and shaken.
The container is placed on a vibrating plate overnight so that the cellulose is completely dissolved.
For the DP measurement, the viscometer (e.g. Ubbelohde) is placed at 25° C. (+/−0.1° C.) using a water bath thermostat and
the cellulose solution is filtered through a glass filter (glass frit Por. 1) before measurement.
Subsequently, 20 ml of the filtrate is filled into the viscometer.
The solution now rests in the viscometer for temperature equalization.
The solution is subsequently pulled up (e.g. with a Peleus ball) and the flow time is stopped.
The flow velocity is measured 4 times per sample and the mean value is calculated.
The specific viscosity is calculated from this.
The specific viscosity is used to calculate the DP.

Further experiments were performed in which an upstream and/or downstream vapor pressure explosion was used to increase the surface of the educt and also to reduce the degree of polymerization. Furthermore, the reactivity of the cellulose is subsequently also higher. These vapor pressure explosions impressively supported the method.

While the present disclosure has been illustrated and described with respect to a particular embodiment thereof, it should be appreciated by those of ordinary skill in the art that various modifications to this disclosure may be made without departing from the spirit and scope of the present disclosure.

1.-17. (canceled)

18. A method for producing a cellulosic polymer, wherein the method comprises:
providing the reactant, namely a mixture of cotton and PET having a fiber length of at most 60 mm-1 mm,
treating the reactant in a reactor with subcritical water at a temperature of 130-200° C., particularly preferably 160° C.-200° C. and a pressure in a range of 1-25 bar, preferably 1-10 bar for approximately 1-120 min, wherein
no catalyst is added and the pH is between 5 and 7 during the entire reaction time,
the method takes place with exclusion of oxygen.

19. A method for producing a cellulosic polymer, wherein the method comprises filtering, washing, pressing, drying, and evaporation in a subsequent step.

20. The method for producing a cellulosic polymer according to claim 18, wherein the product has a cellulose content of at least 90%, preferably 92%, and an average degree of polymerization, which can, however, be predetermined, of 300-1000 DP, preferably 450-650.

21. The method for producing a cellulosic polymer according to claim 19, wherein the product has a cellulose content of at least 90%, preferably 92%, and an average degree of polymerization, which can, however, be predetermined, of 300-1000 DP, preferably 450-650.

22. The method for producing a cellulosic polymer according to claim 18, wherein the reactant can additionally have a part of up to 5% foreign fibers and/or PET.

23. The method for producing a cellulosic polymer according to claim 19, wherein the reactant can additionally have a part of up to 5% foreign fibers and/or PET.

24. The method for producing a cellulosic polymer according to claim 20, wherein the reactant can additionally have a part of up to 5% foreign fibers and/or PET.

25. The method for producing a cellulosic polymer according to claim 18, wherein the reactant can additionally have a metal content part of up to 35 ppm.

26. The method for producing a cellulosic polymer according to claim 19, wherein the reactant can additionally have a metal content part of up to 35 ppm.

27. The method for producing a cellulosic polymer according to claim 20, wherein the reactant can additionally have a metal content part of up to 35 ppm.

28. The method for producing a cellulosic polymer according to claim 21, wherein the reactant can additionally have a metal content part of up to 35 ppm.

29. The method for producing a cellulose polymer according to claim 18, wherein a vapor pressure explosion is performed upstream and/or downstream.

30. The method for producing a cellulose polymer according to claim 19, wherein a vapor pressure explosion is performed upstream and/or downstream.

31. The method for producing a cellulose polymer according to claim 20, wherein a vapor pressure explosion is performed upstream and/or downstream.

32. The method for producing a cellulose polymer according to claim 21, wherein a vapor pressure explosion is performed upstream and/or downstream.

33. The method for producing a cellulose polymer according to claim 22, wherein a vapor pressure explosion is performed upstream and/or downstream.

34. A cellulose produced according to the method of claim 18.

35. Cellulose fibers, in particular viscose or lyocell, produced from the material according to claim 34.

36. A cellulose produced according to the method of claim 19.

37. Cellulose fibers, in particular viscose or lyocell, produced from the material according to claim 36.
